(19) United States
(12) Patent Application Publication
(10) Pub. No.: US 2004/0114370 A1
(43) Pub. Date: Jun. 17, 2004

(54) Flashlight device having at least one light source

(76) Inventor: Karl Pircher, Vienna (AT)

Correspondence Address: WENDEROTH, LIND & PONACK, L.L.P., 2033 K STREET N. W., SUITE 800, WASHINGTON, DC, 20006-1021, US

(21) Appl. No.: 10/682,512

(22) Filed: Oct. 10, 2003

Related U.S. Application Data
(63) Continuation of application No. PCT/AT02/00101, filed on Apr. 4, 2002.

(30) Foreign Application Priority Data
Apr. 11, 2001 (AT) A 581/2001

(51) Int. Cl. F21V 9/00

(52) U.S. Cl. 362/293; 362/202

(57) ABSTRACT

A flash device with at least one light source, comprising at least one filter, in particular a color filter, arranged in front of the light emitting region of the light sources on the flash device. The flash device has a least one support body, with at least two filters, in particular color filters, arranged in said support body. The support body is rotatably mounted, such that, on rotating the support body, various filters, preferably color filters, for influencing the light emitted in the light emitting region of the light source of the flash device, may be provided.

The present invention concerns a flashlight device having at least one light source, wherein at least one filter, in particular a colour filter, is arranged in front of the light emission region of the light source of the flashlight device, wherein the flashlight device has at least one carrier body, wherein at least two filters, in particular colour filters, are arranged in the carrier body.

Flashlight devices of the general kind set forth are known in the state of the art, for example from U.S. Pat. No. 4,365,882. U.S. Pat. No. 4,365,882 discloses a flashlight device for providing colour standards for calibration of the colour reproduction quality of films. The structure shown in that specification is however designed exclusively for the production of defined colour standards and therefore cannot be used, or can be used only to a limited extent, for fast, uncomplicated change in the flash colour in everyday photography.

Therefore the object of the present invention is to provide a flashlight device which is sufficiently robust for daily use and in which various filters can be arranged quickly and without complication in front of the light emission region.

In accordance with the invention that is achieved in that the carrier body is mounted rotatably, wherein by rotation of the carrier body different filters, preferably colour filters, can be arranged to influence light emission in the light emission region of the light source of the flashlight device.

In accordance with the invention therefore it is possible to implement a fast change in the light effects or colour effects of the flashlight device by simply rotating the carrier body. In addition, in desirable embodiments, it is also possible for a combination of filters to be arranged alternately in front of the light emission region of the light source of the flashlight device. In general terms use of the flashlight device according to the invention presents itself together with cameras, without however being restricted thereto. In that respect the term camera embraces all kinds of analog or digital, transportable or stationary photographic or film cameras.

In an advantageous embodiment it is provided that the carrier body is of a cylindrical configuration, wherein preferably at least two filters are arranged in at least one respective part of the peripheral surface of the carrier body.

In preferred embodiments, in that respect, the light emission region of the flashlight device can occupy a spatial angle of 360°, preferably 180°. Other advantageous embodiments provide that the light emission region of the flashlight device occupies a spatial angle of less than 90°, preferably less than 60°.

Furthermore desirable variants provide that at least one carrier body with at least two filters, preferably colour filters, are arranged in positively locking relationship in or at the flashlight device. That however does not exclude the fact that a carrier body with various filters can be simply replaced by another carrier body with other filters by simply pulling one off and fitting one on the flashlight device.

In advantageous variants it is provided that at least one carrier body has three filters, preferably four filters. In addition it is advantageous for the flashlight device to be of a substantially cylindrical configuration. In regard to usual areas of use of flashlight devices, it is desirable for the largest dimension of at least one filter to be between 0.1 and 10 cm, preferably between 1 and 5 cm.

There is a large number of possible options in regard to the choice of filters. Thus advantageous embodiments provide that at least one filter is a grating and/or an intensity filter and/or is spatial angle-selective. In that way initially either the colour of the light emitted by the flashlight but also the intensity thereof can be regulated easily and in particular without expensive electronic control means. In addition however it is also provided that the various filters are of a spatial angle-selective nature. This means that various regions of the space illuminated by the flashlight can be illuminated both with light of varying strength and also with light of differing colour. That affords a wide variety of possible colour and light-dark effects when taking photographs or filming.

In addition it is provided that at least two filters can be arranged alternately manually and/or automatically preferably in conjunction with film transport and/or picture triggering. That means that on the one hand, the desired filter can easily be set by hand or an automatic system automatically changes the filter in dependence on various operating conditions of the camera, for example upon film transport. That is particularly desirable if pictures of a rapid sequence are to be taken with differing light effects.

In that respect the flashlight device according to the invention can in principle be adapted to the most widely varying camera arrangements insofar as the flashlight device can be integrated in the camera or can be selectively arranged removably on the camera or can be actuated as a separate unit from the camera.

Further features and details of the present invention will be apparent from the specific description hereinafter. In the drawing:

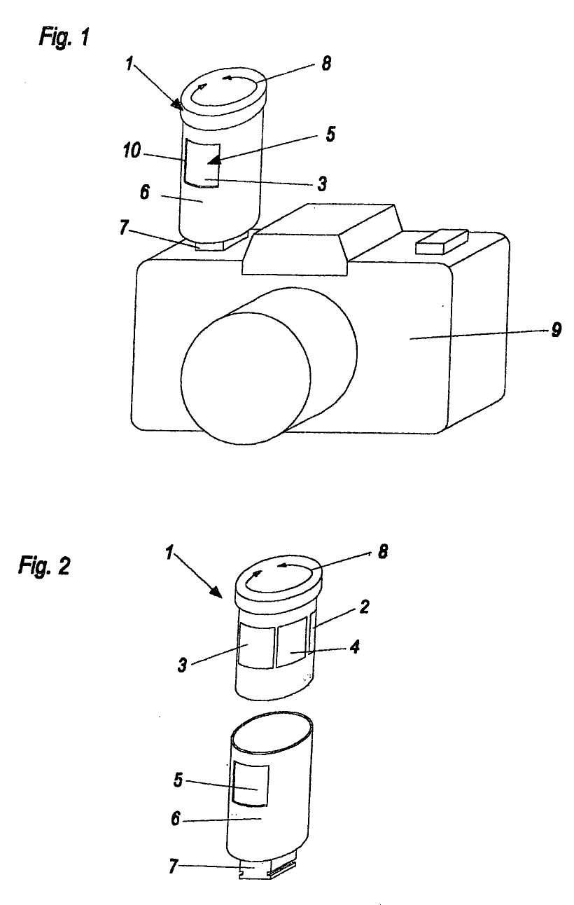

FIG. 1 shows a photographic camera with a flashlight device according to the invention,

FIG. 2 shows a detail view relating to the flashlight device according to the invention, and

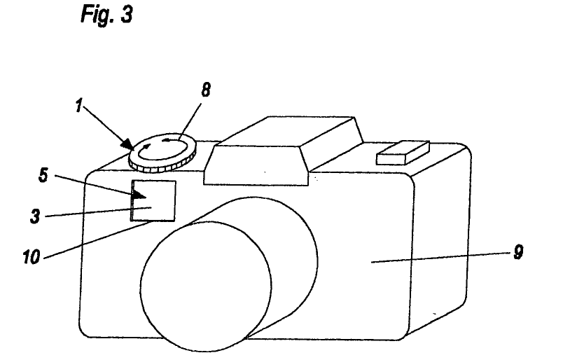

FIG. 3 shows a flashlight device according to the invention which is integrated into a camera.

The flashlight device 6 according to the invention as shown in FIG. 1 is mounted on a camera 9 as is known from the state of the art. Actuation of the flashlight device 6 is effected by the camera 9, as is known in the state of the art, by means of contacts in the foot 7 of the flashlight device 6. The flashlight device 6 has a light emission region 5 in the form of a window 10. The light source of the flashlight device is arranged behind the window 10 of the light emission region 5 (this is not shown here). The filter 3, preferably a colour filter, is arranged between the window 10 of the light emission region 5 and the light source of the flashlight device. In this arrangement the filter 3 is desirably disposed in the carrier body 1, as illustrated in FIG. 2. By rotation of the carrier body 1 in the direction of the double-headed arrow 8 various filters 2, 3, 4 are easily arranged in the light emission region 5 of the flashlight device 6. In this embodiment according to the invention, that makes it possible easily to change the nature of the flash light emitted by the flashlight device 6, by virtue of the rotary movement of the carrier body 1.

FIG. 2 shows the carrier body 1 in a position of being pulled out of the flashlight device 6. In this case the carrier body 1 has the various filters 2, 3 and 4. In this case for example the filter 2 can be a blue filter, the filter 3 a green filter and the filter 4 a red filter. In this respect it is provided in accordance with the invention that all known kinds of filters can be installed in the flashlight device according to the invention. In addition, by simply plugging the carrier body 1 into the flashlight device 6 and unplugging the carrier body therefrom, the embodiment illustrated in FIG. 2 also permits easy replacement of various carrier bodies 1 with various filters 2, 3, 4.

FIG. 3 shows an alternative embodiment in which the carrier body 1 and the flashlight device 6 are integrated into the camera 9. In this alternative embodiment, as in the embodiments illustrated in FIGS. 1 and 2, the carrier body 1 is mounted rotatably so that various filters 2, 3, 4 can be arranged in front of the emission region 5 of the flashlight device 6 by simple rotary movement in the direction of the arrow 8. This variant also in principle affords the option of making the carrier body 1 replaceable so that various carrier bodies 1 with various filters 2, 3, 4 can be fitted into the flashlight device 6 or camera 9.

In addition, it is also already known in the state of the art for flashlight devices to be arranged completely separate and actuable by the camera. In those variants the flashlight devices are generally connected to the camera by way of a cable for transmission of the control pulses. Those alternative configurations can also be implemented with a flashlight device according to the invention (not shown here).

1. A flashlight device having at least one light source, wherein at least one filter is arranged in front of a light emission region of said light source of said flashlight device, wherein said flashlight device has at least one carrier body, wherein at least two filters are arranged in said carrier body, characterised in that said carrier body is mounted rotatably, wherein by rotation of said carrier body different filters can be arranged to influence light emission in said light emission region of said light source of said flashlight device.

2. A flashlight device according to claim 1 characterised in that said carrier body is of a cylindrical configuration, wherein preferably at least two filters are arranged in at least one respective part of the peripheral surface of said carrier body.

3. A flashlight device according to claim 1 characterised in that said light emission region occupies a spatial angle of less than 360° or less than 180°.

4. A flashlight device according to claim 1, characterised in that said light emission region occupies a spatial angle of less than 90° or less than 60°.

5. A flashlight device according to claim 1 characterised in that said carrier body with at least two filters is arranged in positively locking relationship in or at said flashlight device.

6. A flashlight device according to claim 1, characterised in that said carrier body has three filters or four filters.

7. A flashlight device according to claim 1 characterised in that said flashlight device is of a substantially cylindrical configuration.

8. A flashlight device according to claim 1, characterised in that the largest dimension of said filters is between 0.1 and 10 cm or between 1 cm and 5 cm.

9. A flashlight device according to claim 1 characterised in that said filters are grating or intensity filters or are spatial angle-selective.

10. A flashlight device according to claim 1 characterised in that at least two filters can be arranged alternately manually or automatically or in conjunction with film transport or picture triggering.

11. A flashlight device according to claim 1 characterised in that said flashlight device is integrated in a camera or can be arranged selectively removably on a camera or is actuable as a separate device from a camera.

12. A flashlight device according to claim characterised in that said filters are colour filters.
